(19) United States
(12) Patent Application Publication
(10) Pub. No.: US 2008/0217919 A1
(43) Pub. Date: Sep. 11, 2008

(54) Renewable energy wave air pump

(76) Inventor: Shamil Sami Ayntrazi, Vienna, VA (US)

Correspondence Address: Shamil Sami AYNTRAZI, 3101 WHITE DAISY PL, FAIRFAX, VA, 22031, US

(21) Appl. No.: 11/602,901

(22) Filed: Nov. 22, 2006

(51) Int. Cl. F03B 13/12; F03B 13/10; H02P 9/04

(52) U.S. Cl. 290/42

(57) ABSTRACT

In addition to generating power at cost of 0.66 per KWH from a renewable energy source, with minimum pollution and minimum land use, the REWAP system provides four novelties; The First novelty is the REWAP flared bottom to maximize wave energy extraction, and transferring it to ((a)) compressed air, the Second novelty is providing constant power output by feeding the compressed air into the air inlet of a turbo-generator and adding fuel as needed to heat the air to make up the balance of needed power output from the turbo-generator, irrespective of wave height, the third novelty is lack of moving parts, therefore; long plant life and negligible maintenance are achieved, the fourth novelty is a Free Floating Break Water Structure, providing shore line protection without interfering with marine life or obstructing scenic views.

### CROSS-REFERENCE TO RELATED APPLICATIONS

### Listed by USPTO

U.S. Pat. No. 6,388,342 05-2002 Vattrick et al 290/53 US-US005842838A 12-1998 Berg 417/331 U.S. Pat. No. 4,398,095 08-1983 Ono 290/53.

The above do not resemble the REWAP system as proposed under this application.

Although many devices had been invented, none compares with this invention as to simplicity, efficiency and to economy.

References are principles of hydraulic engineering. In addition, the REWAP system can be a stand alone installation or an addition to existing power plants using turbo generators irrespective of the fuel used.

### STATEMENT REGARDING FEDERALLY SPONSORED RESEARCH OR DEVELOPMENT

Not Applicable.

### REFERENCE TO SEQUENCE LISTING, A TABLE, OR A COMPUTER

Not Applicable.

### PROGRAM LISTING

Not Applicable

### COMPACT DISK

Not Applicable

### APPENDIX

Not Applicable

### BACKGROUND OF THE INVENTION

The available renewable energy in the seas and oceans, the cost of new power plants, the rising costs of fuel and the need of environment control: CO2 and other emission of pollutants to the atmosphere and shoreline protection, all dictate investigating and developing new sources of renewable energy.

The oceans cover a little more than 70 percent of the Earth's surface. This makes them the world's largest solar energy collector and energy storage system. According to the World Energy Council, the global energy available from undulation energy conversion is two trillion Watt Hours/year. Tapping just 0.2 percent of this energy would satisfy current global demand for electricity.

During the next 20 years, experts foresee a need for 1,500 GW of additional electric power supply to meet new power demand. This equals to 15,000 new power plants, each 100 MW. It represents building for the next twenty years 100 MW power plants at the rate of 750 per year.

The fuel consumption for these power plants is estimated at 59 million barrels of oil per day. CO2 release to the atmosphere per year is estimated at 2.2 billion tons. The world Bank estimates that developing countries alone will need to spend 100 billion US$ each year for the next 30 years, installing new power plants, most of which will be in the equatorial Zone.

Hence, switching to alternate energy is urgently needed. Among the alternate energy resources, undulation energy is considered as one of the most promising alternate energy source that has high concentration factor compared to wind and solar, and high availability factor (day & night) compared to Solar energy.

Civilizations can be tied to, indeed equated to energy utilization. America consumes nearly a quarter of the world power supply. That is 4% of the population consumes 25% of world power.

### BRIEF SUMMARY OF THE INVENTION

Periodic waves in an expanse body of water are a renewable energy source having both potential and kinetic energies. The idea is to transfer these energies to a pressurized volume of air, collect ((it)) and feed it to the air intake of a turbo generator, further compress ((it)) and heat it to drive a turbine and raise the energy of the generated electric power energy of the to the required level at reduced fuel consumption.

The apparatus proposed for this energy transfer is a Renewable Energy Wave Air Pump (REWAP). The advantages are economical and easy installation, minimum maintenance as there no moving parts, leveling wave power pulses, maintaining required power output by adding fuel to compensate for reduced wave energy availability, ((does)) produces less pollutants, does not disturb marine life or shore scenic view and acts as a floating break water structure.

Installing a set of ten REWAP's units in the path of 4-meter sea waves, 333 sets wide (total 3,330 REWAP's) in an area measuring 30>1000 meters would pull out and deliver 50 mega watts of energy to the air inlet of a ((a)) turbo generator.

The cost per KWH is 0.66 compared with 5.113 cents for a conventional power plant.

### BRIEF DESCRIPTION OF THE SEVERAL VIEWS OF THE DRAWINGS

FIG. 1 REWAP System Flow Diagram

FIG. 2 REWAP Isometric View

FIG. 3 REWAP Elevation View

FIG. 4 REWAP System Elevation View

FIG. 5 REWAP System Plan View

### LISTING OF TABLES

Table 1 REWAP power generation and undulation height

Table 2 Electric Power Costs Per KWH

### DETAILED DESCRIPTION OF THE INVENTION

When you see an undulation go by, you think of it as the water moving. Well, it's not the water it's the kinetic and potential energy within the water that's making it seem to move. The energy within the undulation has a high flow (Q) at a low head (H).

The idea is to pull out part of the energy in a surface wave to an equivalent amount in compressed air, enclosed in the upper portion of the REWAP, collect and feed it to mechanical equipment for further utilization. There are four novelties in the proposed REWAP system.

The First novelty is amplifying and maximizing energy extraction by the REWAP pump, by providing it with a flared bottom, i.e. having an entry area larger than the inside of the pump. This amplifies and maximizes kinetic energy transfer from the rushing water as it moves up the conic section into the smaller area of the pump, to the trapped air inside the pump to increase its compression, consequently its stored energy. This is in addition to the compression resulting from the potential energy of the wave imparted to compress the air.

The Second novelty is providing constant power output level by feeding the compressed air into the air inlet of a turbo-generator and adding fuel as needed to heat the air to make up the balance of power output needed from the turbo-generator. Undulations have variable heights and variable durations. Therefore, no constant power output can be achieved using any other system.

The third novelty is lack of moving parts, therefore; long plant life and negligible maintenance are achieved.

The fourth novelty is a Free Floating Break Water Structure, providing shore line protection without interfering with marine life or obstructing scenic views. This novelty had been proposed by this inventor under Renewable Energy Wave Pump Application number 2006/0097520.

The additional energy produced by the REWAP system and fed as compressed air into the air inlet of a turbo-generator would be manifested by increasing the output at reduced fuel consumption to generate the same power as under normal operating conditions.

A series of deep-water REWAP's are installed along the path of the undulation, each pulling out a portion of the undulation energy until most of the energy is pulled out and stored in the form of compressed air.

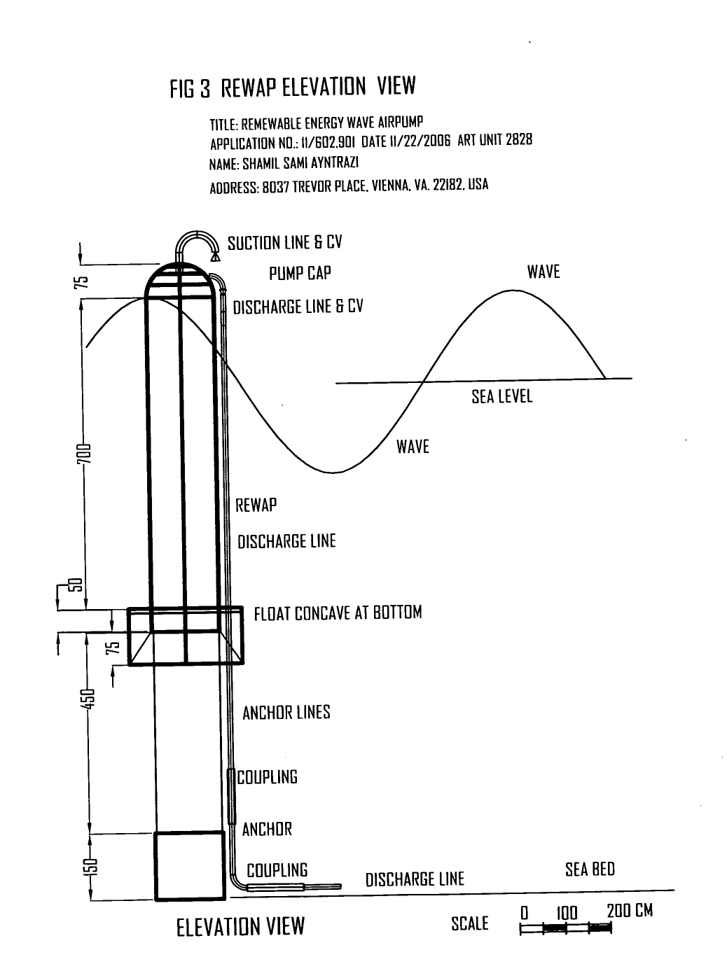

As the undulation has an apparent motion from left to right, the following actions take place as shown in FIG. 3; REWAP System Elevation View.

The water inside the REWAP rises in proportion with the height of the incoming wave and compresses the air trapped inside the REWAP pump and closes the suction check valve, thus pulling out part of the potential energy. The water under the pump would rush inside the pump to further compress the trapped air in the pump by imparting most of its kinetic energy.

The novelty here is to provide the pump with a flared bottom, i.e. having an entry area larger than that of the pump. The rushing water as it moves up the conic section into the smaller area of the pump would impart most of its kinetic energy to the trapped air inside the pump to further compress it.

When the air pressure inside the REWAP is more than the pressure in the discharge pipe, the discharge check valve opens and the compressed air is released into the piping network that feed into the air intake of a turbo-generator.

As the wave recedes, the water level inside the REWAP drops, the trapped air pressure inside the pump decreases below atmospheric pressure, thus opening the suction check valve, the discharge check valve being closed by the higher pressure in the discharge piping network. Fresh air supply would fill the volume of the pump above the water line, making it ready for the next incoming undulation front and repeat the cycle of compressing the trapped air in the pump and discharging it into the discharge piping network.

The REWAP discharge line has a flexible connection to the piping network that is run and anchored to the sea bed, to allow for limited horizontal pump swing. Also it has another flexible connection to allow ease of connection due to construction misalignment of the piping network installed and anchored to the sea bed.

The pump float, in addition to providing a flared water entry into the REWAP, it provides a vertical lifting force to keep the pump vertical and limit horizontal swing of the pump.

High waves, if they occur and totally cover the REWAP do not limit the operation of the pump. Water entering into the pump via the suction line would be dissipated into the sea and has no effect, water vapor in the discharge line would improve the efficiency of the turbo-generator as it acts as a fogging system.

The variable water elevations due to ebb/tide action and to seasonal sea elevation changes, also do not limit the operation of the REWAP.

A Red flashing warning light is installed on top of the REWAP for navigation safety, and the red color of the pump make the clearly visible day and night.

The REWAP system has a low cost, is easy to manufacture and install, and requires no maintenance as there are no moving parts except for the check valves which are accessible from outside.

Ten REWAP's are installed and spaced along the path of the undulation in such a manner as to fully pull out and level most of the energy in the wave.

The electric energy of the generator is locally distributed to local consumers, or synchronized and connected to the public electric utility network.

The surface water behind the REWAP's is calm, since the wave pumps had pulled out most of the undulation energy. The REWAP system acts as a Floating Break Water Structure, thus providing Shoreline protection.

The system does not disturb marine life or sea utilization. The REWAP system covers an area 1,000 to 1,500 meters long, 30 meters wide, and requires a minimum sea depth of 14 meters.

### FIELD OF THE INVENTION

The present invention refers to a method and apparatus for electric power generation from a renewable energy source namely, periodic sea undulations. It proposes an apparatus and system for exchanging the energy of a surface water undulation to compress air in the upper portion of the REWAP, collect and discharge it into a turbo-generator, where it is compressed, heated and used to drive a turbo generator.

The stored energy in the compressed air would be manifested by increasing the output of the turbo-generator and reducing the fuel consumption and emission of pollutants to the atmosphere.

### History

The first patent on wave energy usage was filed about 400 years ago. This device was just a barge connected by a long lever with a water pump. It was never built because of technical difficulties.

Although many wave energy devices had been invented, only a small proportion have been tested and evaluated. Furthermore, only a few have been tested at sea, in ocean waves, rather than in artificial wave tanks.

A wave energy converter may be placed in the ocean in various possible situations and locations. It may be floating or submerged completely in the sea, or it may be located on the shore or on the seabed in relatively shallow water. Apart from wave-powered navigation buoys, however, most of the prototypes have been placed at or near the shore.

As of the mid-1990s, there were more than 12 generic types of wave energy systems. Some systems extract energy from surface waves others extract energy from pressure fluctuations below the water surface, or from the full wave. Some systems are fixed in position and let waves pass by them, while others follow the waves and move with them. Some systems concentrate and focus waves, which increases their height and their potential for conversion to electrical energy.

As of the mid-1990s, wave energy conversion was not commercially available in the United States. The technology was in the early stages of development and was not expected to be available within the near future due to limited research and lack of federal funding.

As of 1995, 685 kilowatts (kW) of grid-connected wave generating capacity is operating worldwide. This capacity comes from eight demonstration plants ranging in size from 20 kW to 350 kW. None of these plants are located in California, although economic feasibility studies have been performed for a 30 MW wave converter to be located at Half Moon Bay. Additional smaller projects have been discussed at Fort Bragg, San Francisco and Avila Beach. There are currently no firm plans to deploy any of these projects.

Interest in renewable sources of energy was revived after the first serious oil crisis, about 30-years ago. Then, more advanced schemes were developed as listed under achievements below.

### General

The material of the REWAP could be any material suitable for marine installation and has enough strength to withstand the forces acting on its elements, including those under storm conditions.

The dimensions of the individual REWAP elements are variable and depend upon site conditions such as: low and high sea water elevations, Undulation heights, required wave pump output, load requirements as to type and output.

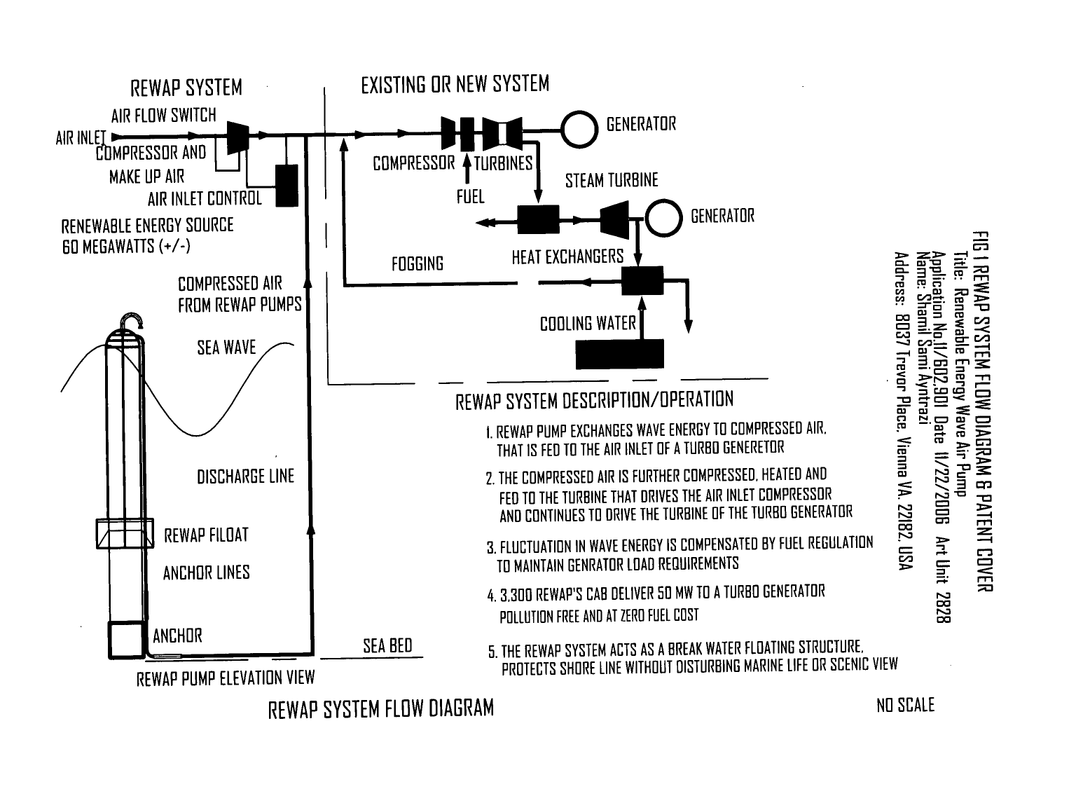

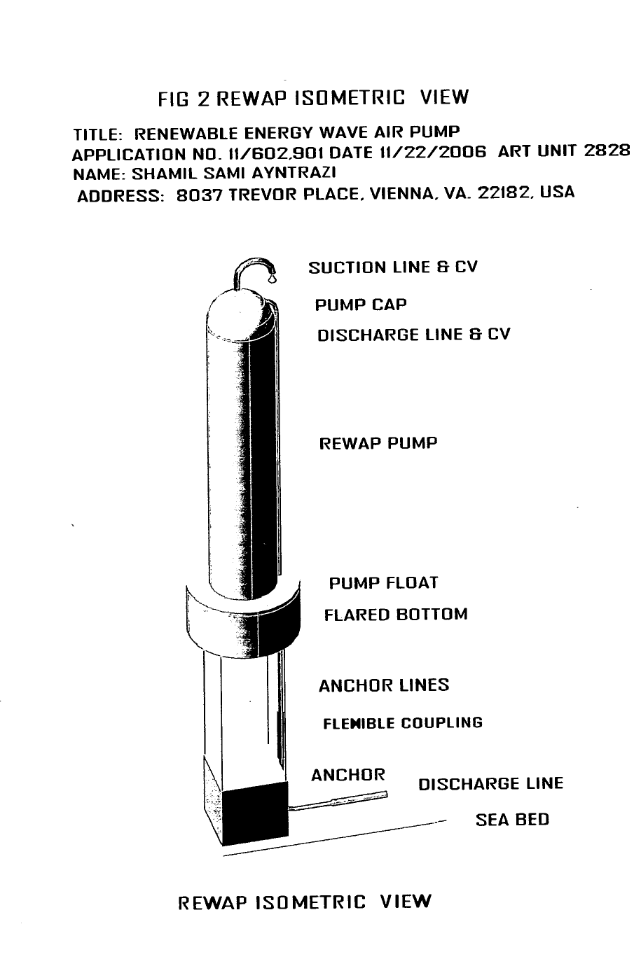

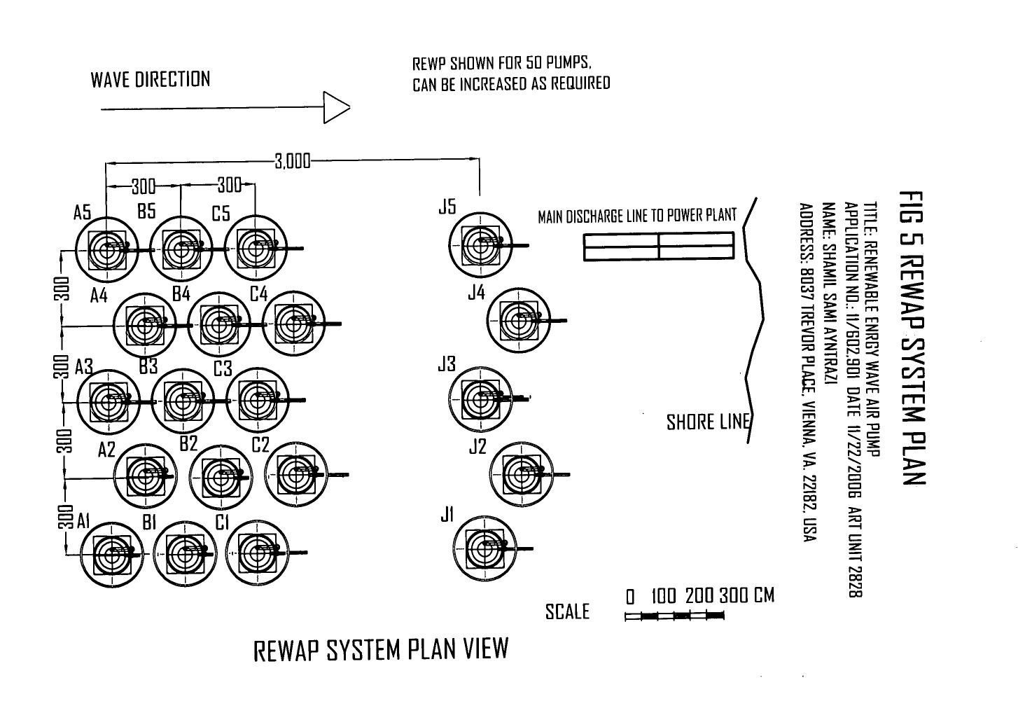

The example below shows a typical installation for REWAP elements and their respective dimensions. All dimensions are shown in centimeters. FIG. 1 to FIG. 5 show the arrangement of the REWAP system.

PUMP BODY; Cylindrical, hollow, open bottom, red color, 150 cm outside diameter, 750 cm length, 2 cm wall thickness (thickness depend on material used), capped with a hollow hemisphere, 150 cm outside diameter, 2 cm wall thickness (thickness depend on material used). Pump Body is installed vertically and partially immersed in the water, kept 250 cm above the maximum sea water level by a pump float fixed to its bottom and anchored to the sea bed.

PUMP CAP is provided with suction and discharge lines and respective one way check valves.

RED FLASHING navigation light is provided on top of the pump cap, clearly visible by day and night, and provided with electric power by means of electric cables suitable for marine installation running between the power plant and the red flashing lights and fixed to the discharge piping network.

PUMP FLOAT; Hollow, made of two sections; upper section cylindrical 150 cm outside diameter, 250 cm inside diameter, 2 cm thick, capped by a 250 cm cylindrical disc 2 cm thick on top and bottom, and a hollow lower conical cylinder section with 250 cm outside diameter at top and 150 cm at base rigidly secured to the REWAP lower end, as shown in FIG. 1 REWAP ELEVATION VIEW. The Pump Float provides an upward lift of 3,670 kg to keep the REWAP in vertical position and limit its horizontal swing.

A SCREEN is provided at the bottom of the pump float with suitable size and mesh to prevent the ingress of suspended and other materials into the pump.

FLEXIBLE LINES; 600 cm long, anchor the bottom of the REWAP to the seabed at four diametrically opposite points each capable of withstanding a working tensile force of 6,000 kilograms

SUCTION LINE; fixed to the top of the Pump Cap and provided with a one way check valve that opens on the lee side of the wave and closes when water inside of the REWAP rises with the front side of the wave. The size of suction pipe and its check valve depend on Pump diameter and prevailing wave height.

DISCHARGE LINE; fixed to the side or top of the Pump Cap, and provided with a one way check valve that opens with the water rise inside the REWAP and when the air pressure inside the pump exceeds that after the check valve, and closes with the lee side of the wave. The discharge line is run and fixed to the outside of the Pump Body and discharges into a piping network anchored to the sea bed. The Discharge Line connects to the piping network with two flexible couplings; one vertical to absorb limited horizontal pump swings, and a one horizontal to adjust construction misalignment with the pipes.

PIPING NETWORK; a piping network collects the air discharged from individual REWAP□s into a main header to feed compressed air at the inlet of a turbo-generator.

Turbo-Generator; may be an existing installation in a power plant, or a new installation. The compressed air output from the REWAP□s is fed at the air intake. An additional air turbine with necessary controls is provided in the air intake circuit to ensure that air always flows into the turbo-generator.

### Calculation

As water is incompressible, while air is, a large amount of kinetic energy is transferred from the water rushing up the REWAP to the air trapped in the upper portion of the pump, to compress it further. The trapped air in the pump is compressed by two ways: one by the level of water outside the pump which is higher than the water inside the pump on the incoming wave front, the second by the kinetic energy in the rushing water in the pump. The rushing water has the same mass, but it has 2.78 times (2.5×2.5/1.5×1.5) its velocity as it enters the pump. Therefore, a large portion of the kinetic energy found in the rushing water is transferred and stored in compressing the trapped air in the REWAP.

The dimensions of the REWAP□s and their spacing depend on site conditions, power and load requirements. The variables are ebbs and tides, seasonal low and high sea water elevations, undulation height and frequency, contour of the seabed, type of load and power requirements. The following example is based on a 4 meter high wave

Wave height=4 meters.

Wave front=1 meter.

Wave period=9 seconds.

Available power in incoming one meter wave front=0.42*H*H*9 KW=0.42×4×4×9=60.48 KW

The available wave energy in an area 1,000 meters wide is 60.48 megawatts.

Assuming 10 REWAP□s are installed in line with the apparent wave path can extract 90% of the wave energy, and assuming the friction loss of the compressed air in the piping network is 7% then the extracted energy delivered at the air inlet of the turbo generator is =60.48*0.90*0.93=50.62 megawatts.

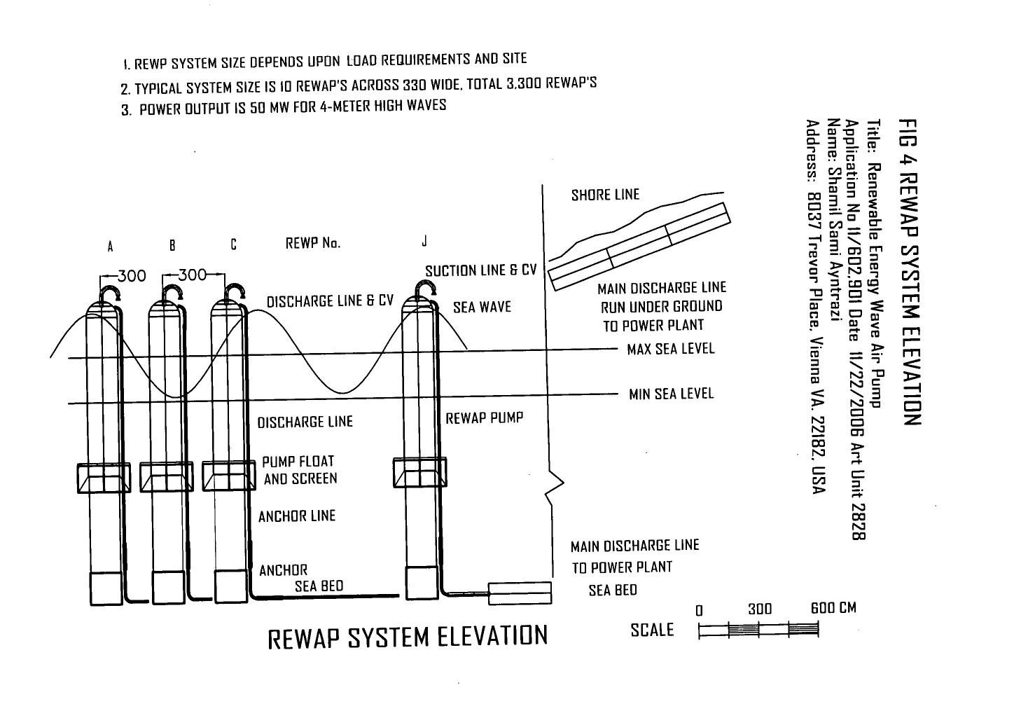

FIG. 4 REWAP Schematic Flow Diagram shows a set of ten (10) REWAP's installed along the path of the incoming surface undulations. Each of these's would pull out a bit of energy from the incoming surface undulation, until most of the potential and kinetic energy had been pulled out.

The REWAP system operates even if the wave undulation has low heights.

The REWAP system can be installed as a modification to an existing power plant using turbo generators, or as an additional power source in a new power plant.

### Undulation Incidence and Power

TABLE 1
REWAP power generation and undulation heights

| Wave | | Incidence | Power | Incidence | Power | Incidence | Power |
|---|---|---|---|---|---|---|---|
| Height | Electrical | Per Year | Generated | Per Year | Generated | Per Year | Generated |
| m | Power KW | Hours | Mwhours | Hours | Mwhours | Hours | Mwhours |
| Wave Power Level KW | | | 11.8 | | 16.4 | | 34.5 |
| 1 | 3.2 | 5,006 | 20.0 | 4,103 | 13.0 | 1,515 | 4.8 |
| 2 | 14.2 | 1,939 | 38.8 | 1,982 | 28.1 | 2,663 | 37.8 |
| 3 | 34.2 | 742 | 34.9 | 944 | 32.2 | 1,875 | 63.5 |
| 4 | 64.8 | 249 | 21.9 | 445 | 28.4 | 1,296 | 82.7 |
| >4.5 | 78.0 | 130 | 13.0 | 33 | 25.7 | 1,463 | 114.1 |
| | Totals | 8,066 | 95.2 | 7,804 | 127.6 | 8,795 | 303.0 |
| Wave Power Level KW | | | 19.9 | | 25 | | 37.4 |
| 1 | 3.2 | 3,764 | 11.9 | 3,846 | 16.8 | 1,077 | 3.4 |
| 2 | 14.2 | 2,200 | 31.2 | 2,488 | 49 | 2,759 | 39.2 |
| 3 | 34.2 | 1,032 | 35.3 | 964 | 45.7 | 1,875 | 64.1 |
| 4 | 64.8 | 536 | 34.2 | 41 | 3.6 | 1,226 | 78.2 |
| >4.5 | 78.0 | 634 | 49.4 | 139 | 13.9 | 1,831 | 142.8 |
| | Totals | 8,166 | 162.1 | 7,478 | 184.1 | 8,769 | 327.8 |

### Storm Conditions

The REWAP system can withstand storm conditions with no limitation on undulation height, or wind speed. The anchor system keeps the pumps in place and upward lift provided by the pump float limits and resists horizontal swing.

### Safety to Navigation and Environment

The area at the sea surface is a series of red pump caps clearly visible during the day, and a series of flashing red navigation warning lights clearly visible at night.

The REWAP system does not disturb marine life or sea utilization. For a 50 MW power plant, the area covered is 1,000 meters long, 30 meters wide, extending downward for 14.5 meters to the seabed as shown in the example. The underwater structures are open pump casings having an outside diameter of 150 cm open at the bottom and spaced at 3 meters (C-C), and have variable depths of 15 meters or more, depending on seabed elevation. These pump casings are terminated to an open and screened pump float.

### Economic Analysis

The following represents a general solution for the calculation of energy costs per (Kilowatthours):

Electric Power Costs Per KWH−US$

Costs−US$/KWH=(1/E)*K[r+½n]+M/E+F/E

K US$/KW Capital cost

E KWH/KW Annual production (full load hours)

F/E US$/KWH Fuel cost

R % Interest rate per annum

N years Return period on investment

M/E US$/KWH Maintenance cost

TABLE 2
Electric Power Costs Per KWH = (1/E)*K[r + 1/2n] + M/E + F/E

| | | | RRST-FO 1% | RRST-NG | CCGT-NG | REWP | REWAP |
|---|---|---|---|---|---|---|---|
| Item | Unit | Description | 3ST | 3ST | 2GT + 1ST | Hydro Turb | GT |
| | MW | Plant Capacity - MW | 450 | 450 | 450 | 50 | 50 |
| | Million US$ | Installation Cost | 495 | 495 | 279 | 20 | 8 |
| | Million US$ | Fuel Cos/Year (2005) | 117.88 | 117.88 | 105.14 | 0.00 | 0.00 |
| M | Million US$ | Operation and | 7.82 | 5.57 | 4.57 | 0.381 | 0.10 |
| | | Maintenance/Year | | | | | |
| | | Generation GWH/Year | 2,700 | 2,700 | 2,700 | 143 | 143 |
| K | US$/KW | Capital Cost | 1,100 | 1,100 | 620 | 400 | 160 |
| | | Actual Power Generated/ | 0.68 | 0.68 | 0.68 | 0.33 | 0.33 |
| | | Maximum Power | | | | | |
| | | Generation | | | | | |
| E | Hours/Year | Full load Operation | 6000 | 6000 | 6000 | 2856 | 2856 |
| r | % | Interest Rate/Year | 8 | 8 | 8 | 8 | 8 |
| n | Years | Return Period on | 20 | 20 | 20 | 20 | 20 |
| | | Investment | | | | | |
| M/E | US$ | Maintenace Cost/KWH | 0.002896 | 0.002063 | 0.001693 | 0.002664 | 0.000699 |
| F/E | US$ | Fuel Cost/KWH | 0.04366 | 0.04366 | 0.03894 | 0.00 | 0.00 |
| C | US$ | Generation Cost/KWH | 0.06581 | 0.06497 | 0.05148 | 0.01737 | 0.00658 |
| C | US$ | Generation Cost/KWH | 6.58 | 6.50 | 5.15 | 1.74 | 0.66 |

Table 2 Electricity Costs per Kilowatt-hour shows actual data from a recent power plant with different fuels used and for different types of turbines. Depending upon type of turbines and fuel used, the average cost per KWH varies between 5.148 and 6.581 US cents, for a 450 MW electric power plant.

### Note:

Fuel Oil consumption 185 grams/KWH

Fuel Oil Cost US$ 208/KTOE

Fuel Oil Cost based on US$ 32/barrel

NG Consumption 7.58 cubic foot/KWH

NG Cost based on US$ 4,160/Mcubic foot

The average cost per KWH for a 50 MW REWAP power plant is 0.66 cents per KWH.

The fuel cost component per KWH varies between 3.894 and 4.366 US cents, are equivalent to Fuel cost savings per KWH for a REWAP system, since the fuel cost for a REWAP system is Zero.

Installation savings per KW for a range between US$ 460 (620−160) and US$ 940 (1,100−160).

### Financial Return and Undulation

Reduction in power generation for a REWAP system due to maintenance shutdown is nil, since shutdown is scheduled during the months of calm seas. Therefore, the power generated is governed by undulation heights, incidence and duration.

Undulation height and duration depend upon the geographic location. To determine a factual figure for power generation, a log of the sea undulations as to heights and respective durations per year to be provided as shown in Table 1 power generation and undulation heights.

For this feasibility study an REWAP system with a capacity of 50 MW is assumed to provide a minimum of 143,000,000 KWH per year. That is, it operates at full capacity for 2,856 hours per year. That is, 33% of the time at full load capacity. This is equivalent to four months availability of 4 meters high waves during a 12 month period.

### Financial Return

### 50 MW, 4-Meters Undulations

The fuel savings per year for 143,000,000 KWH/year varies between 5,568,420 and US $ 6,243,380 (143,000,000×3.894/100 and 143,000,000×4.366/100).

The US$ 8 million capital investment for the 50 MW REWAP power plant is reclaimed in less than 2 years, due to fuel savings alone.

Alternately as shown in Table 2: For a 50 MW REWAP power plant, generating a minimum of 143,0000,000 KWH per year, with an installation cost of US$ 8,000,000 (at the rate of US$ 160 per KW), a life span of 20 years and a rate of return of 8%:

The maximum cost price per KWH is US Cents 0.66 compared with a minimum of US Cents of 5.113 per KWH for a conventional power plant. Therefore, there is a net profit of US Cents 4.453 per KWH. This translates into a net profit per year over and above the eight (8%) rate of return on invested capital equal to: US$ 6,367,779 for 143,000,000 KWH/year.

### Other Financial Rewards

Due to present laws for protecting the environment and maintaining a clean air, the US government gives an incentive equivalent to US Cents 0.96 for each KWH generated using a renewable energy source, such as: Solar, Wind, Sea, Geothermal, Organic or similar source of energy. This means that for a 50 MW REWAP power plant there is: a yearly incentive equivalent to US$ 1,372,800.

The REWAP provides a 1,000 meter long Floating Break Water Structure to protect against shoreline erosion.

What is claimed is:

1. I claim: Renewable Energy Wave Air Pump (REWAP), as an aggregate apparatus and system for changing the energy in a periodic surface undulation of an expanse body of fluid into usable form, irrespective of water surface level, undulation amplitudes; and comprising; a hollow cylinder vertically installed in water, protruding above the water line, closed on top with a flared open bottom, and provided with Suction and Discharge Lines and respective Check Valves, anchored to the sea bed by flexible anchor lines. and an anchor, and is kept vertical by a concave pump float surrounding its lower end, the air inside the cylinder is compressed by the potential and kinetic energies of the sea wave, is discharged through a piping network and common headers directly to a turbo generator air inlet, to produce electric prime or additional power at zero or reduced fuel consumption respectively.

2. I claim: Floating Break Water Structure consisting of a field of Renewable Energy Wave Air Pumps (REWAP□s) as described under claim 1 above, for protection of ports, harbors, and sea shore line.
